(19) United States
(12) Patent Application Publication
(10) Pub. No.: US 2026/0243265 A1
(43) Pub. Date: Aug. 20, 2026

(54) MAGNETIC LEVITATION PROPELLER TYPE OF A GAS INJECTOR AND A PHOTORESIST REMOVING PROCESSING CHAMBER WITH THE SAME

(71) Applicant: VM Inc., Icheon-si (KR)

(72) Inventors: Sang Woo LEE, Suwon-si (KR); Woo Hyung CHOI, Seongnam-si (KR)

(21) Appl. No.: 19/559,939

(22) Filed: Mar. 6, 2026

(30) Foreign Application Priority Data
Feb. 18, 2025 (KR) 10-2025-0020481

(51) Int. Cl. F04D 25/04; F04D 29/058; F04D 29/32; F04D 29/38

(52) U.S. Cl. CPC F04D 25/045; F04D 29/058; F04D 29/325; F04D 29/384; F04D 29/388; F05D 2240/51

(57) ABSTRACT

Provided is a magnetic levitation propeller type of a gas Injector and a photo resist removing processing chamber with the same. The magnetic levitation propeller type of a gas injector includes: a plurality of rotating wings 112_1 to 112_K extending from a central shaft 111; a circular rotating ring magnetic unit 15 surrounding the plurality of the rotating wings 112_1 to 112_K; a first circular fixed ring magnetic unit 12 arranged so that at least a portion thereof faces the rotating ring magnetic unit 15 upward and downward; and a second circular fixed ring magnetic unit 13 arranged at a location symmetric to the first fixed ring magnetic unit 12 with respect to the rotating ring magnetic unit 15, wherein the plurality of rotating wings 112_1 to 112_K rotates between the first and second fixed ring magnetic units 12, 13 in a magnetically levitated state depending on a gas flow.

### BACKGROUND OF THE INVENTION

### FIELD OF THE INVENTION

The present invention relates to a magnetic levitation propeller type of a gas injector and a photoresist removing processing chamber with the same, in particular to a gas injector with a magnetic levitated propeller structure installed for spraying a plasma uniformly to a wafer and a photoresist removing processing chamber with the same.

This work was supported by Next-generation Intelligence Semiconductor Foundation grant funded by the Korea government (the Ministry of Science and ICT, the Ministry of Trade, Industry and Energy) (RS-2024-00407627, Development of high-productivity and low-damage hybrid atomic layer etching equipment for sub-10nm Deep Trench Silicon architecture).

### DESCRIPTION OF THE RELATED ART

In a semiconductor process, an etching process is a process for protecting a portion covered with a PR (Photoresist) by mask-treating with the PR in advance and removing the other portion without the PR by a plasma using a selectivity of a target material with respect to the PR for forming a required pattern. A portion covered with the PR may be removed during the etching process, and the higher the process characteristic selectivity becomes, the less the PR is removed. The target material is etched by a multiple of the selectivity as the PR is etched by plasma. In this process, even though a height of the PR may be formed very accurately, a margin may be generated. And as a result, after an etching of required amount of the target material is performed, some PR may remain. Such remaining PR residue can be removed by a PR strip process or an ashing process.

As the PR strip process removes the PR residue through a chemical reaction using radicals within the plasma, the selectivity of the PR residue with respect to a remaining material may be considered as nearly infinite. And also, because the PR strip process is not a process for forming patterns, the economic productivity expressed as a treated number of wafers per time may be the most important factor of the PR strip equipment. To increase the productivity in the ashing process, it is important for a density of the radicals generated at a remote plasma source to be increased, but it is very crucial for the generated radicals to be delivered uniformly on the wafer in an active condition. The radicals have a high reactivity, and therefore, the radicals may react to disappear easily if a friction is generated or the radicals meet other materials in the course of being delivered. And the productivity may be increased when the radicals are delivered uniformly on the wafer to enhance the process uniformity. This principle is analogous to a time difference between scratching a lottery ticket with a coin and scratching it with a ballpoint pen tip.

As the process for removing the PR residue is a process where the selectivity is nearly infinite, it is important for the wafer surface to be scratched uniformly. As shown in FIG. 5, a known PR removing chamber may comprise a base block 51 displaced within a housing H; a susceptor 52 displaced on an upper surface of the base block 51 and securing a wafer; an edge ring 53; a heater 54 displaced within the susceptor 52; a shower head 55 displaced above the susceptor 52; a plasma opening 57; a remote plasma source 56; and a pressure controller. In order to enhance the uniformity of the radical flow to reach the wafer surface, it is necessary for a plasma P to pass through the shower head 55 and to be sprayed uniformly on a surface of the wafer W.

But the radicals passing through the shower head 55 passes through a pipe extending from the remote plasma source 56 to the shower head 55, and then, at an upper surface of the shower head 55, the radicals move to be distributed at each hole formed at the shower head 55. And then the radicals pass through the showerhead hole to reach on the surface of wafer W fixed on the susceptor 52. In this process, a significant amount of radicals may be lost owing to a frequent surface friction. A dilemma that the productivity is lowered in the process of improving the productivity may arise. An optimizing design is required considering such correlation. However, the optimizing condition may be different depending on each process condition and an inner environment of the chamber, thus many kinds of optimized designed shower heads 55 may be required. However, the known or prior art does not disclose a technique for spraying the plasma uniformly on the surface of the wafer while a surface friction is reduced to minimize a radical loss.

The present invention has the following objective for solve the problems of the prior art.

### PURPOSE OF THE INVENTION

An object of the present invention is to provide with a magnetic levitation propeller type of a gas injector and a photoresist removing processing chamber with the same capable of removing a PR residue by spraying a plasma guided from a remote plasma source uniformly on an upper surface of a wafer.

### SUMMARY OF THE INVENTION

In one embodiment of the present invention, a magnetic levitation propeller type of a gas injector comprises a plurality of rotating wings extending from a central shaft; a circular rotating ring magnetic unit surrounding the plurality of the rotating wings; a first circular fixed ring magnetic unit arranged so that at least a portion thereof faces the rotating ring magnetic unit upward and downward; and a second circular fixed ring magnetic unit arranged at a location symmetric to the first fixed ring magnetic unit with reference to the rotating ring magnetic unit, wherein the plurality of rotating wings rotates between the first and second fixed ring magnetic units in a magnetically levitated state depending on a gas flow.

In another embodiment of the present invention, the first and the second circular fixed ring magnetic unit are arranged at a circular groove formed an inner surface of a fixed block having a hollow cylindrical shape.

In still another embodiment of the present invention, the rotating ring magnetic unit is formed integrally with the plurality of rotating wings and arranged within a receiving frame with a sealed structure.

In still another embodiment of the present invention, a width of each rotating wing increases gradually as each rotating wing extends from the central shaft to an outside.

In still another embodiment of the present invention, a center of gravity of the central shaft is located below a middle portion of the shaft.

In still another embodiment of the present invention, the first and second circular fixed ring magnetic unit have a greater magnetic force than that of the rotating ring magnetic unit.

In still another embodiment of the present invention, the gas injector further comprises at least one spraying nozzle arranged at an outside of a circular frame connecting outer edges of the plurality of rotating wings.

In still another embodiment of the present invention, the gas injector further comprises at least one rotation guiding blade formed at the circular frame.

In still another embodiment of the present invention, an inert gas is sprayed through the at least one spraying nozzle.

In still another embodiment of the present invention, a processing chamber for removing a PR residue is provided.

### BRIEF DESCRIPTION OF THE DRAWINGS

FIG. 1 shows an embodiment of a magnetic levitation propeller type of a gas injector according to the present invention.

FIG. 2 shows another embodiment of a magnetic levitation propeller type of a gas injector according to the present invention.

FIG. 3 shows an embodiment of a processing chamber for removing a PR residue according to the present invention.

FIG. 4 shows an embodiment of a method for removing a PR residue using the processing chamber according to the present invention.

FIG. 5 shows a chamber for removing a PR residue according to the known art.

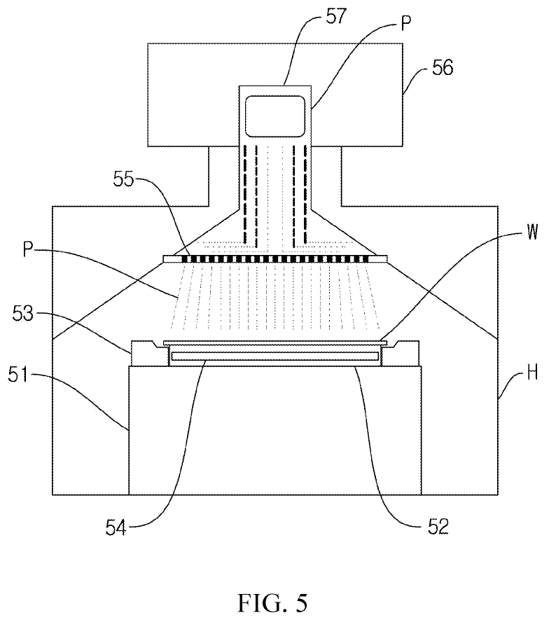

### DETAILED DESCRIPTION OF EXEMPLARY EMBODIMENTS

Exemplary embodiments of the present invention will be described herein below with reference to the accompanying drawings.

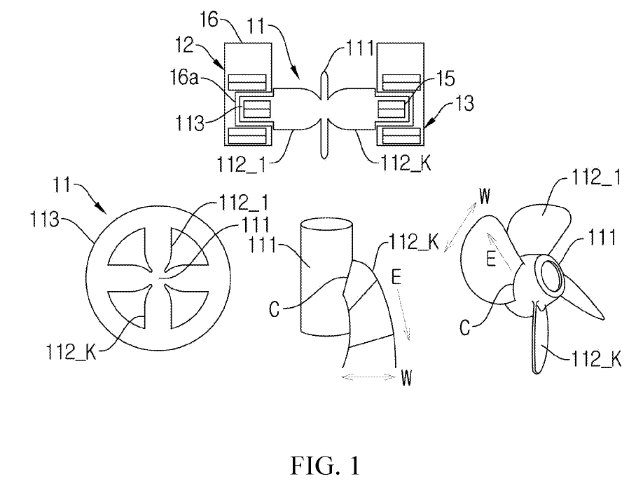

FIG. 1 shows an embodiment of a magnetic levitation propeller type of a gas injector according to the present invention.

Referring to FIG. 1, a magnetic levitation propeller type of a gas injector comprises a plurality of rotating wings 112_1 to 112_K extending from a central shaft 111; a circular rotating ring magnetic unit 15 surrounding the plurality of the rotating wings 112_1 to 112_K; a first circular fixed ring magnetic unit 12 arranged so that at least a portion thereof faces the rotating ring magnetic unit 15 upward and downward; and a second circular fixed ring magnetic unit 13 arranged at a location symmetric to the first fixed ring magnetic unit 12 with respect to the rotating ring magnetic unit 15, wherein the plurality of rotating wings 112_1 to 112_K rotates between the first and second fixed ring magnetic units 12, 13 in a magnetically levitated state depending on a gas flow.

A propeller module 11 may comprise the central shaft 111 extending vertically; the plurality of rotating wings 112_1 to 112_K extending from the central shaft 111 along a radial direction; and the circular receiving frame 113 connecting outer edges of the rotating wings 112_1 to 112_K each other. The propeller module 11 can rotate about the central shaft 111, and the central shaft 111 may have a rod shape having a cylindrical shape or a circular cross section and extending vertically.

The plurality of rotating wings 112_1 to 112_K may extend from the central shaft 111 along the radial direction, and the plurality of rotating wings 112_1 to 112_K may be formed integrally with the central shaft 111. A width of each rotating wing 112_1 to 112_K may increase gradually along the extending direction, and the plurality of rotating wings 112_1 to 112_K may have equal extending lengths. The outer edges or end portions of the plurality of rotating wings 112 to 112_K may be connected each other to form the circular receiving frame 113. As shown in the upper part of FIG. 1, the receiving frame 113 may be formed integrally with the plurality of rotating wings 112_1 to 112_K and have a rectangular cross section, but not limited to.

A circular rotating ring magnetic unit 15 may be received within the receiving frame 113, and the rotating ring magnetic unit 15 may have various shapes where two magnetic poles may be located up and down while being received within the receiving frame 113. For example, if the receiving frame 113 has a rectangular cross section, then the rotating ring magnetic unit 15 extending in a circular direction along the inside of the receiving frame 113 may have a rectangular cross section.

In this way, if the rotating ring magnetic unit 15 has a circular shape on the whole and has the rectangular cross section, then the rotating ring magnetic unit 15 may be arranged within the receiving frame 113 so that an N pole and an S pole are positioned vertically. The first fixed ring magnetic unit 12 may be displaced to face the rotating ring magnetic unit 15 vertically. As shown in FIG. 1, the first fixed ring magnetic unit 12 may be displaced above the rotating ring magnetic unit 15, and at least a portion of the fixed ring magnetic unit 12 may face the rotating ring magnetic unit 15 with a gap formed between the first fixed ring magnetic unit 12 and the rotating ring magnetic unit 15. The first fixed ring magnetic 12 may have a structure surrounding the plurality of rotating wings 112_1 to 112_K, and the first fixed ring magnetic unit 12 may have a rectangular cross section. Specifically, if the rotating ring magnetic unit 15 has a rectangular cross section, then the first fixed ring magnetic unit 12 may have a rectangular cross section. The first fixed ring magnetic unit 12 may be positioned outside and above the plurality of rotating wings 112_1 to 112_K. And the cross section of the first fixed ring magnetic unit 12 may be located above the cross section of the rotating ring magnetic unit 15 separated by a distance and may extend outside so as to be parallel to the cross section of the rotating ring magnetic unit 15. The first fixed ring magnetic unit 12 may have a relatively larger magnetic force than that of the rotating ring magnetic unit 15, and have a larger extending length than that of the rotating ring magnetic unit 15.

The second fixed ring magnetic unit 13 may have the same or similar structure as the first fixed ring magnetic unit 12 and may be displaced below the rotating ring magnetic unit 15. Specifically, the second fixed ring magnetic unit 13 may be arranged symmetric to the first fixed ring magnetic unit 13 with respect to the rotating ring magnetic unit 15. The first and second fixed ring magnetic units 12, 13 may be separated from each other by a distance in a vertical direction, may have equal or similar structure and may have ring shapes where the centers are located on the same vertical axis or Z-axis line. And also, the cross sections of the first and second fixed ring magnetic units 12, 13 along Z-axis direction may be a rectangular shape, respectively.

The rotating ring magnetic unit 15 may be located between the first and second fixed ring magnetic unit 12, 13 arranged in this way, and the center of the rotating ring magnetic unit 15 may be positioned on the Z-axis line where the centers of first and second fixed ring magnetic units 12, 13 is positioned. The cross section of the rotating ring magnetic unit 15 may be rectangular shape, and the length of the rotating ring magnetic unit may be smaller than those of the first and second fixed ring magnetic units 12, 13. And the rotating ring magnetic unit 15 may be arranged between the first and the second fixed ring magnetic units 12, 13 as in an inserted shape. The N and S poles of the rotating ring magnetic unit 15 may be arranged vertically, and the N poles and S poles of the first and the second fixed ring magnetic units 12, 13 may face the N pole and the S pole of the rotating ring magnetic unit 15, respectively. Therefore, the rotating ring magnetic unit 15 may be maintained between the first and the second fixed ring magnetic unit 12, 13 as in a levitated state.

In an embodiment of the present invention, the first and the second fixed ring magnetic units 12, 13 may be arranged at a circular groove 16a formed at an inner surface of a fixing block 16 having a hollow cylindrical shape. The fixing block 16 may have a predetermined height and thickness, and have a hollow cylindrical or drum shape where a top surface and a bottom surface is opened. The propeller module 11 may be displaced within the fixing block 16, and the circular groove 16a may be formed where the receiving frame 113 of the propeller module 11 can be inserted. And the first and the second rotating ring magnetic units 12, 13 may be arranged at an upper surface and a lower surface of the circular groove 16a, respectively. Thereby, the rotating ring magnetic unit 15 may be separated from the first and the second fixed ring magnetic units 12, 13 by an equal or a similar interval, respectively. And the rotating ring magnetic unit 15 may be maintained in a state separated apart from the circular groove 16a. The first and the second rotating ring magnetic units 12, 13 may be fixed above and below the rotating ring magnetic unit 15, respectively, but not limited to.

Referring to the propeller module 11 shown in the lower part of FIG. 1, four rotating wings 112_1 to 112_K may extend from the central shaft 111 along the radial direction, and the four rotating wings 112_1 to 112_K may be formed to have the same circumferential angle each other. Different rotating wings 112_1 to 112_K may have an equal or a similar shape each other, and each rotating wing 112_1 to 112_K may extend from the central shaft 111 as the width of each rotating wings 112_1 to 112_K increases gradually along the radial direction.

For example, each rotating wing 112_1 to 112_K may form a jointing portion C inclined to a circumferential surface of the central shaft 111, and the jointing portion C may have a curved shape. Each rotating wing 112_1 to 112_K may have a twisted structure and the width of each rotating wing 112_1 to 112_K may increase along the extending direction. Specifically, each rotating wing 112_1 to 112_K may have a structure to disperse a gas or a plasma introduced from an upper direction downward as a streamlined shape. Owing to such structure of each rotating wing 112_1 to 112_K, when the gas or the plasma may be input from the above to the propeller module 11, the propeller module 11 may be rotated in a levitated state by the first and the second fixed ring magnetic units 12, 13 and the rotating ring magnetic unit 15. And by the rotation of the rotating wings 112_1 to 112_K the gas or the plasma may be introduced to an upper surface of a wafer W located below. And also, because each rotating wing 112_1 to 112_K may extend with the width increasing gradually and may be made as the twisted structure, the gas or the plasma introduced to the lower direction may be dispersed uniformly to contact the upper surface of the wafer W for removing a PR residue. For example, the propeller module 11 may be made of a material such as an aluminum or an engineering plastic, but not limited to. And also, the propeller module 11 may have various number of rotating wings 112_1 to 112_K, but not limited to.

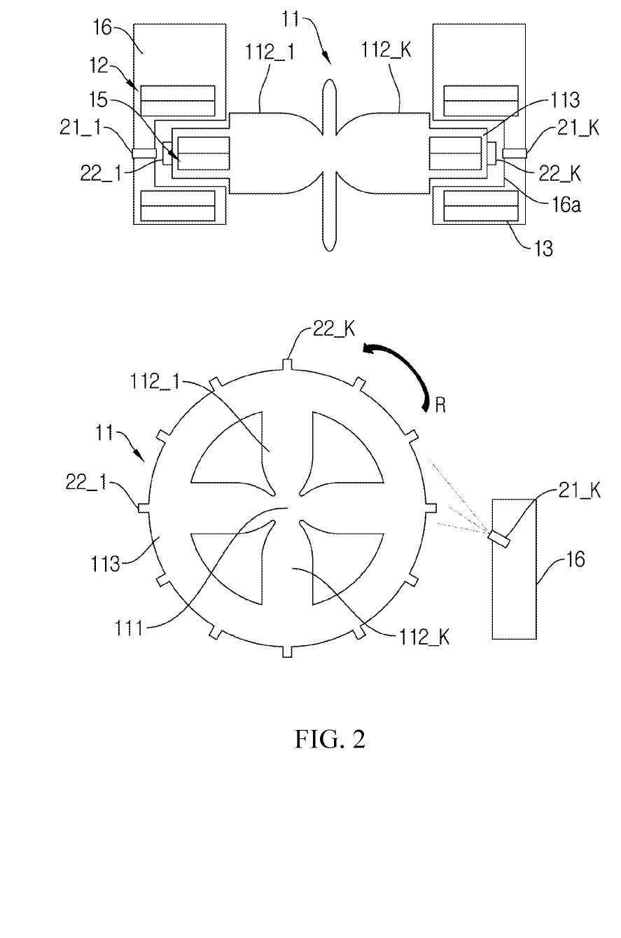

FIG. 2 shows another embodiment of a magnetic levitation propeller type of a gas injector according to the present invention.

Referring to FIG. 2, the gas injector further comprises at least one spraying nozzle 21_1 to 21_K arranged at the outside of a circular frame 113 connecting outer edges of the plurality of rotating wings 112_1 to 112_K. And the gas injector further comprises at least one rotation guiding blade 22_1 to 22_K formed at the circular frame 113. And an inert gas is sprayed through the at least one spraying nozzle 21_1 to 21_K.

As disclosed above, the propeller module 11 may rotate in its own way by the gas or radicals flowing in from the above without a separate power supply. But when the propeller module 11 operates for a long time, various foreign materials such as a polymer may be accumulated, for example, at a gap between the propeller module 11 and the circular groove 16a. And the propeller module 11 may not rotate in a proper speed owing to a friction resistance generated from such the accumulated foreign materials. And also, the rotating speed of the propeller module 11 need to be controlled depending on a structure of an ashing chamber or a strip chamber where the propeller module 11 is installed. In order to rotate the propeller module 11 forcibly or to control the speed of the propeller module 11, at least one spraying nozzle 21_1 to 21_K may be installed.

The at least one spraying nozzle 21_1 to 21_K may be installed at a periphery of the propeller module 11 to spray a gas such as an inert gas, for example a helium or an argon, or a nitrogen towards the circular receiving frame 113. For example, the spraying nozzle 21_1 to 21_K may be installed at the fixing block 16 to spray the gas to the receiving frame 113 for rotating the propeller module 11. The spray nozzle 21_1 to 21_K may spray the gas in a direction inclined to the surrounding surface of the receiving frame 113 or in a tangential direction for rotating the propeller module 11, and one or more spraying nozzles 21_1 to 21_K may be installed for spraying.

In an embodiment of the present invention, guiding blades 22_1 to 22_K for rotating the propeller module 11 may be formed at the surrounding surface of the receiving frame 113, wherein the sprayed gas from the spraying nozzle 21_1 to 21_K may be impacted on the guiding blades 22_1 to 22_K. One or more guiding blades 22_1 to 22_K may be formed along the surrounding surface of the receiving frame 113, and a plurality of guiding blades 22_1 to 22_K may be formed uniformly along the surrounding surface of the receiving frame 113. Each guiding blade 22_1 to 22_K may extend vertically from the surrounding surface of the receiving frame 113 in a rectangular plate shape, but not limited to. Each guiding blade 22_1 to 22_K may be made into various structures to rotate the propeller module 11 by an impact of the gas sprayed from the spraying nozzle 21_1 to 21_K, but not limited to.

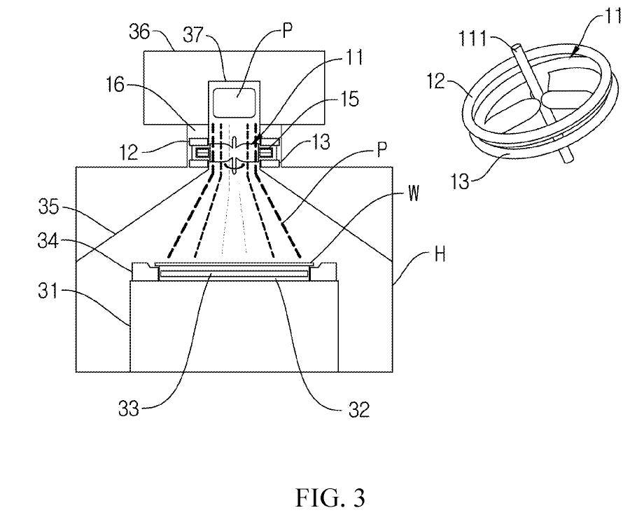

FIG. 3 shows an embodiment of a processing chamber for removing a PR residue according to the present invention.

Referring to FIG. 3, the ashing chamber or the strip chamber may comprise a housing H, and the base block 31 with a cylindrical shape may be formed within the housing H. And a susceptor 32 may be displaced on an upper surface of the base block 31. A heater 33 may be arranged within the susceptor 32, and an edge ring 34 may be arranged along an edge of the upper surface of the base block 31 to fix the wafer W. And also, a dome 35 made from a material such an aluminum and having a truncated cone shape may be installed an upper part of the housing H to prevent the plasma P from flowing in the upper direction of the housing H. A gas opening 37 for introducing the plasma P generated from a remote plasma source 36 into the inside of the housing H may be formed at the upper part of the housing H.

In the ashing chamber or the strip chamber having such a structure, the photoresist remaining at the surface of the wafer W may be removed by the plasma P introduced through the shower head installed at the upper part of the housing H. When the shower head is applied, the plasma P generated from the remote plasma source 36 may be introduced to the upper part of the shower head through the gas opening 37. Thereafter, the plasma P may flow though penetrated holes formed uniformly at the shower head to be introduced to the upper surface of the wafer W. Inducing the plasma P by the shower head may enhance a uniformity, but have a problem that the radicals are lost due to the frequent friction of the plasma P to make it difficult for the radicals to be delivered efficiently to the surface of the wafer W.

According to the invention in order to solve such problems, the injector may be installed at the opening 37, and the plasma P introduced to the opening 37 may pass through the propeller module 11. The propeller module 11 may be installed within the fixing block 16, and the propeller module 11 may be maintained in a levitated state by the rotating ring magnetic unit 15 and the first and the second fixed ring magnetic units 12, 13. The propeller module 11 may self-rotate around the central shaft 111, as the plasma P passes through the propeller module 11, and thus the plasma P can flow uniformly downward. The plasma can be induced uniformly to the upper surface of the wafer W, while the plasma P is prevented from flowing upward by the truncated cone shape of dome 35 installed at the upper part of the housing H. In such way, the gas injector according to the present invention may reduce a contact frequency of the radicals, and make the plasm P be induced uniformly to the upper surface of the wafer W. And in such structure of the magnetic levitation, the injector may also prevent particles from being generated.

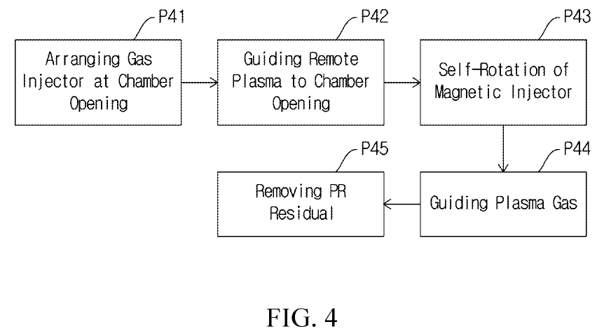

FIG. 4 shows an embodiment of a method for removing a PR residue using the processing chamber according to the present invention.

Referring to FIG. 4, a method for removing the photoresist residue comprises a step P41 of installing a gas injector at an opening of a chamber where a plasma generated from a remote plasma source is introduced; a step P42 of introducing the plasma into the opening of the chamber; a step P43 of self-rotating a propeller module of the gas injector as the plasma passes through the gas injector; a step P44 introducing the plasma uniformly into an upper surface of a wafer by the self-rotation of the propeller module; and a step P45 of removing the photoresist remaining on the upper surface of the wafer.

The gas injector may comprise the propeller module and a first and a second fixed ring magnetic unit surrounding the outside of the propeller module and arranged vertically. And also, the propeller module may comprise a plurality of rotating wings and a rotating ring magnetic unit arranged at a receiving frame surrounding the rotating wings. If the plasma passes through the propeller module, then the propeller module may self-rotate in a levitated state at the step P43. The plasma may be induced to the upper surface of the wafer by the self-rotation of the propeller module at the step P44, and the photoresist residue may be removed at the step P45.

The gas injector may have various structure to induce the plasma downward by the magnetic levitation, but not limited to.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A magnetic levitation propeller type of a gas injector comprising:
a plurality of rotating wings extending from a central shaft;
a circular rotating ring magnetic unit surrounding the plurality of the rotating wings;
a first circular fixed ring magnetic unit arranged so that at least a portion thereof faces the rotating ring magnetic unit upward and downward; and
a second circular fixed ring magnetic unit arranged at a location symmetric to the first fixed ring magnetic unit with respect to the rotating ring magnetic unit,
wherein the plurality of rotating wings rotates between the first and second fixed ring magnetic units in a magnetically levitated state depending on a gas flow.

2. The gas injector according to claim 1, wherein the first and the second circular fixed ring magnetic units are arranged at a circular groove formed an inner surface of a fixed block having a hollow cylindrical shape.

3. The gas injector according to claim 1, wherein the rotating ring magnetic unit is formed integrally with the plurality of rotating wings and arranged within a receiving frame having a sealed structure.

4. The gas injector according to claim 1, wherein a width of each rotating wing increases gradually as each rotating wing extends from the central shaft to an outside.

5. The gas injector according to claim 1, wherein a center of gravity of the central shaft is located below a middle portion of the shaft.

6. The gas injector of the claim 1, wherein the first and second circular fixed ring magnetic units have a greater magnetic force than that of the rotating ring magnetic unit.

7. The gas injector according to claim 1, wherein the gas injector further comprises at least one spraying nozzle arranged at an outside of a circular frame connecting outer edges of the plurality of rotating wings.

8. The gas injector according to claim 7, wherein the gas injector further comprises at least one rotation guiding blade formed at the circular frame.

9. The gas injector according to claim 7, wherein an inert gas is sprayed through the at least one spraying nozzle.

10. A processing chamber for removing a PR residue according to claim 1.

11. A processing chamber for removing a PR residue according to claim 2.

12. A processing chamber for removing a PR residue according to claim 3.

13. A processing chamber for removing a PR residue according to claim 4.

14. A processing chamber for removing a PR residue according to claim 5.

15. A processing chamber for removing a PR residue according to claim 6.

16. A processing chamber for removing a PR residue according to claim 7.

17. A processing chamber for removing a PR residue according to claim 8.

18. A processing chamber for removing a PR residue according to claim 9.
